(19) United States
(12) Patent Application Publication
(10) Pub. No.: US 2015/0197680 A1
(43) Pub. Date: Jul. 16, 2015

(54) THERMALLY CONDUCTIVE POLYMER AND RESIN COMPOSITIONS FOR PRODUCING SAME

(71) Applicant: DR. NEIDLINGER HOLDING GMBH, Ostfildern-Kemnat (DE)

(72) Inventor: Jochen FRANK, Aichwald (DE)

(21) Appl. No.: 14/665,157

(22) Filed: Mar. 23, 2015

Related U.S. Application Data
(63) Continuation of application No. PCT/EP2013/059220, filed on May 3, 2013.

(30) Foreign Application Priority Data
Oct. 5, 2012 (DE) DE 102012109500.0

(51) Int. Cl. C09K 5/14

(52) U.S. Cl. CPC C09K 5/14

(57) ABSTRACT

The present invention relates to a polymerizable resin composition comprising at least one polymerizable resin components selected from the group consisting of polyols, polyamines and mixtures thereof, wherein said polymerizable resin contains at least 75 wt. % of aluminum hydroxide composition relative to 100 wt. % of the resin composition.

### BACKGROUND OF THE INVENTION

The present invention relates to polyurethane polymers with increased thermal conductivity and to polymerizable resin compositions, to hardener compositions and to inorganic filler mixtures, which inter alia can be used for producing such polymers.

In the course of the current developments in the electromobility field and in particular in the field of electric vehicles, such as for example automobiles but also busses and goods vehicles, it has been found that in the field of the incorporation of storage media for electrical energy, that is in the incorporation of batteries and battery systems, materials with an extremely complex requirement profile are required. Firstly, such materials should have adequate flexibility and elasticity in order to achieve an adequate damping effect against the vibrations arising in the operation of the vehicle. Further, the materials should have adequate thermal conductivity, in order for example to conduct heat arising during the charging process away from the energy storage media, in order to avoid damage there. At the same time, however, such materials should also display as high as possible electrical insulation, since flashover of electricity from the storage media for example onto the bodywork must be prevented, in order to prevent a risk for example to the vehicle passengers. Further, for safety reasons the materials to be used should display adequate self-extinguishing properties and also, for secure incorporation, remain dimensionally stable in the long term.

It has been found that the requirement profile as regards elasticity and high electrical insulation can only be achieved with use of polymeric materials. As regards the attainment of the necessary thermal conductivity, attempts have already for some time been made to increase the thermal conductivity of polymers by addition of thermally conducting fillers, wherein care must again be taken that the electrical insulation properties are not lost as a result.

With regard to the processability of such filled polymers, the starting materials should in turn have a viscosity which is adjustable over a broad range as required, wherein particularly with regard to the production of polymer molded articles by molding processes a low viscosity can be of value. With regard to this problem, reference may in particular be made to the publication by J. Frank in Kleben & Dichten [Adhesives and Seals], 1-2/2012, which gives a general discussion of the conflict between thermal conductivity and viscosity.

With regard to production and costs, it would also be advantageous if the materials used could be produced with as few as possible different components. In addition, particularly from the logistical viewpoint, it would be advantageous if the starting materials used for the production of the thermally conductive materials were storage stable for a long time, for example as regards settling behavior or even reactivity.

In the state of the art, various polymer systems loaded with inorganic fillers are already known, however it was found that at present there is still no material available which has all the aforesaid properties in ranges which are adequate for use for example in electrically powered vehicles.

Thus for example in the dissertation by Wolfgang Übler (“Erhohung der thermal conductivity elektrisch isolierender Polymerwerkstoffe” [Increasing the thermal conductivity of electrically insulating polymer materials], Technische Fakultät der Universität Erlangen-Nürnberg, 2002, obtainable in the German National Library), exten-sive studies on epoxide resin systems, which inter alia were loaded with aluminum oxide particles of various sizes, are described.

Even when polymers with acceptable thermal conductivity and high electrical insulation were obtained with the systems described there, since these polymer-ize to very hard and brittle materials, the systems described there are only suitable for use in electrical vehicles to a limited extent, because of the poor elasticity and hence the poor damping action. Further, in this document, no statements whatever are made on the question of self-extinguishing properties.

Further, the epoxy resins described in this document are produced by firstly producing a mixture of resin and hardener and then introducing the fillers into this mixture, as a result of which, in view of the increased processing cost and the fact that the products obtained do not display the homogeneity necessary for use as thermally conducting materials, this process has been found suitable only to a limited extent for indus-trial scale use in thermally conducting materials. The latter can also been seen from the fact that considerable doubts exist as to the storage stability of a previously produced mixture of epoxy resin and aluminum oxide.

JP 2002-138205 describes a thermally conducting polymer in the form of a silicone which is loaded with up to 70 vol.% of a thermally conducting filler. Here, this filler can consist of up to 90 vol.% of a metal hydroxide, in particular aluminum hydroxide, wherein the difference is made up by other fillers, such as for example aluminum oxide.

The polymer system known from this document has first and foremost the disadvantage that this is a silicone-based system, which is not in general suitable or desirable for installation for example in electrical vehicles owing to the fact that migration of monomers can often occur even after curing.

Further, silicones have the problem that for example under a weight load, such as can occur due to batteries in an electrical vehicle, these have a tendency to creep, that is, these can irreversibly deform with time, which is also undesirable for installation in the automobile industry.

Further, on reading the document, it also appears that the desired thermal conductivity can only be achieved by admixture of the further filler, namely aluminum oxide, which markedly complicates the formulation.

From JP 2004-342758 A, thermally conductive polymers based on a polyurethane which is filled with aluminum hydroxide particles are known.

Admittedly, the polymers known from this document have in the best case an acceptable thermal conductivity of ca. 0.9 W/m*K, however on the basis of the aluminum hydroxide content of 44 vol.% in the finished polymer it must be assumed that this was only achieved at the expense of a low degree of crosslinking in the polymer, as also emerges from the low NCO index described in this document. Such a material is admittedly suitable for use as relatively thin polymer film in electronic devices, however on the basis of the low degree of crosslinking and the low mechanical stability resulting from this, such polymers are not suitable for use in the electromobility field.

Further, resin compositions loaded with aluminum hydroxide, for example based on polyols, are generally known, but until now it was assumed that at a loading of 70 wt. % a limit is reached after which such laden resin compositions can no longer be reliably processed.

In the light of the above statements, it is thus an object of the present invention to describe a material which is characterized both by high thermal conductivity and also high electrical insulation and good elasticity and long term dimensional stability.

It is a further object of the present invention to describe a polymerizable resin composition or a hardener composition with which a polymer as described above can be produced, whose viscosity is adjustable in a broad range, where in particular the viscosity should be such that the compositions are suitable for use in molding processes.

A further objective of the present invention is to describe an inorganic filler composition with which the aforesaid compositions and polymers can be produced.

### SUMMARY OF THE INVENTION

The present inventors have now surprisingly discovered that by specific formulation, in particular a specific selection of the fillers, resin compositions with aluminum hydroxide fill levels of 75 wt. % and more and hardener compositions with aluminum hydroxide fill levels of 70 wt. % and more can be produced, which still have good processability and in particular useful viscosities.

In one aspect, the invention therefore relates to a polymerizable resin composition comprising one or more polymerizable resin components selected from the group consisting of polyols, polyamines and mixtures thereof, in particular polyether polyols, polyester polyols and polybutadiene polyols, aluminum hydroxide and optionally other additives, such as for example wetting and dispersant additives, dyes, pigments, drying agents, fillers, polyalcohols, butanediol, hexanediol, antifoaming agents, antisettling agents, plasticizers such as for example phosphates, and catalysts, wherein the resin composition contains at least 75 wt. %, and in particular 75 to 85 wt. % of aluminum hydroxide, relative to 100 wt. % of the resin composition.

In a further aspect, the present invention relates to a hardener composition comprising one or more hardener components selected from the group consisting of the isocyanates, in particular the aromatic isocyanates and the aliphatic isocyanates, for example methylene diphenyl diisocyanate, hexamethylene diisocyanate, toluene diisocyanate and prepolymers thereof, aluminum hydroxide and optionally other additives, such as for example wetting and dispersant additives, dyes, pigments, drying agents, fillers, antifoaming agents, antisettling agents, plasticizers such as for example phosphates, and catalysts, wherein the hardener composition contains at least 70 wt. %, and in particular 70 to 85 wt. % of aluminum hydroxide relative to 100 wt. % of the hardener composition.

In a further aspect, the invention relates to a polymer molded article which is produced by polymerization of the aforesaid resin composition with use of said hardener composition.

In a further aspect, the invention relates to a polymer selected from polyurethanes, polyureas and mixtures or copolymers thereof, wherein the polymer contains more than 50 vol.%, preferably more than 55 vol.% and in particular more than 60 vol.% of aluminum hydroxide relative to 100 vol.% of the polymer.

In a further aspect, the invention relates to an inorganic filler mixture which contains aluminum hydroxide and preferably essentially consists of aluminum hydroxide, wherein the aluminum hydroxide is present in the form of at least four filler components,
wherein the first filler component has an average particle size of 75 to 150 μm, preferably 80 to 125 μm,
wherein the second filler component has an average particle size of 10 to 60 μm, preferably 30 to 50 μm,
wherein the third filler component has an average particle size of 1 to 5 μm, preferably 2 to 4 μm, and
wherein the fourth filler component has an average particle size of 3 μm or less, preferably 0.5 to 3 μm.

In a further aspect, the invention relates to the use of the filler mixture described for improving the thermal conductivity of polymers.

In a further aspect, the invention relates to a polymerizable resin composition comprising one or more polymerizable resin components selected from the group consisting of polyols, polyamines and mixtures thereof, in particular polyether polyols, polyester polyols, and polybutadiene polyols, the aforesaid inorganic filler mixture, and optionally further additives, such as for example wetting and dispersant additives, dyes, pigments, drying agents, fillers, polyalcohols, butanediol, hexanediol, antifoaming agents, antisettling agents, plasticizers such as for example phosphates, and catalysts.

In a further aspect, the invention relates to a hardener composition comprising one or more hardener components selected from the group consisting of isocyanates, in particular aliphatic and aromatic isocyanates, for example methylene diphenyl diisocyanate, hexamethylene diisocyanate, toluene diisocyanate and prepolymers thereof, the aforesaid inorganic filler mixture, and optionally further additives, such as for example wetting and dispersant additives, dyes, pigments, drying agents, fillers, antifoaming agents, antisettling agents, plasticizers such as for example phosphates, and catalysts.

In a further aspect, the invention relates to a polymer selected from polyurethanes, polyureas and mixtures or copolymers thereof, which contains the aforesaid inorganic filler mixture.

It has now been found that a polymerizable resin composition or a hardener composition according to the invention can be used to produce a flexible, but at the same time stable polyurethane polymer which displays both good thermal conductivity and high electrical insulation and also excellent self-extinguishing properties.

The polyurethane polymers produced from the polymerizable resin composition or using the hardener composition further have the advantage that they have sufficient elasticity for use in electrically powered vehicles and excellent long-term dimensional stability.

The polymerizable resin compositions and hardener compositions further have the advantage that it has been found that in spite of the relatively high loading with fillers these can be produced in viscosities which are well suited for example for use in molding processes.

Here, it has here in particular been found that the inorganic filler compositions according to the invention enable a high loading of resin compositions and hardener compositions with at the same time low viscosity.

The polymerizable resin composition according to the invention contains one or more resin components from the group of polyols or polyamines and mixtures thereof. A resin component in the sense of the invention can be any polyol, polyamine or any mixture of such components which can be converted by a reaction with an isocyanate to a polyurethane, polyurea polymer or corresponding copolymers. Here, the resin components include both functional polymers and prepolymers, but also simple monomers. The precise nature and combination of the resin components can here be selected by those skilled in the art on the basis of their expert knowledge with regard both to the desired properties of the resin composition and also the properties of the finished polymer. In the sense of the invention, a mixture of polyol and polyamine can be both a mixture of at least two components and also a single component with hydroxy and amine functionali-ties.

The hardener composition according to the invention contains at least one hardener component from the group of the isocyanates. The hardener components include all isocyanates known to those skilled in the art and used in polyurethane and polyurea production. These can both be monomeric and also prepolymerized isocyanates. The precise nature, quantity and combination of the isocyanate(s) can here be selected by those skilled in the art on the basis of their expert knowledge and with regard to the desired properties of the polymer. Aromatic and aliphatic isocyanates, for example methylene diphenyl diisocyanate, hexamethylene diisocyanate and/or toluene diisocyanate or prepolymers thereof, are preferably used in the hardener component.

The aluminum hydroxide used in the polymerizable resin composition, the hardener composition, the filler mixture and the polyurethane polymer of the invention can be any form of aluminum hydroxide which is familiar to those skilled in the art and which is commercially available, as long as the size of the particles varies in the range which is usual for fillers in the polymer industry. With regard to processability, the upper limit for the average particle size here usually lies in the range of 500 μm and lower, preferably in the range of 200 μm and lower and in particular at 150 μm at most.

With regard to the form of the aluminum hydroxide particles and with regard to as effective as possible space filling, it is preferable if the aluminum hydroxide particles are not present in the form of particles with a high aspect ratio, such as for example in the form of platelets of fibers. It is particularly preferable if the aluminum hydroxide particles are present in the form of spherical or approximately spherical particles.

The further additives which can optionally be present in the resin composition can be any additives known to those skilled in the art, which are for example used to influence the processability, storage stability, pot life or also the viscosity of the polymerizable resin composition or the hardener composition of the invention or to impart further properties to a polymer to be produced therefrom.

Further it is also possible that polymerizable resin compositions, hardener compositions and polymers of the invention contain other inorganic fillers, for example for improving the thermal conductivity. In the latter case, such fillers can be present in any quantity, provided that not less than the minimum content of aluminum hydroxide according to the invention is present.

The average particle size of a filler component according to the invention is understood to mean the d₅₀ value. The d₅₀ value is the particle size at which 50 vol.% of the particles of the filler components are finer than the d₅₀ value and 50 vol.% are coarser.

In the context of the invention, a filler component is understood to mean a filler with a peak in the particle size distribution. In other words, the filler mixture according to the invention displays at least four peaks in the particle size distribution, wherein the peaks lie in the aforesaid particle size ranges. In the context of the invention it is possible here to use the components individually for production of the filler mixture, the resin composition, the hardener composition or the polymer or to mix them. In the context of the invention, it is also provided and possibly advantageous to use two or more filler components in the form of a pre-prepared filler mixture.

In the context of the invention, the numbering of the filler components is not intended to mean any kind of ordering or prioritization but serves only to distinguish the filler components from one another.

The ranges particle size distributions for the third and fourth filler component of the invention overlap. Here it is clear to those skilled in the art that in the context of the invention it makes no difference which of the two components has what average particle size, inasmuch as two filler components are present whose average particle sizes lie in the respective stated ranges. In the context of the invention it is possible that the average particle diameters of two, one or none of the filler components lie in the overlap range. For example, it would be possible that the third filler component has an average particle diameter of 4 μm and the fourth filler component an average particle diameter of 0.7 μm (no filler component in the overlap range). A further example in the context of the invention is a filler mixture in which the third filler component has an average particle diameter of 2.5 μm and the fourth filler component an average particle diameter of 0.7 μm (one filler component in the overlap range). A further example in the context of the invention is a filler mixture in which the third filler component has an average particle diameter of 2.5 μm and the fourth filler component an average particle diameter of 1.5 μm (both filler components in the overlap range). The fact that in the above examples the average particle diameter of the third filler component is always greater than that of the fourth filler component served only for simplicity and has no effects on the scope of protection.

In the context of the present invention, the expression “have/contain” or “having/containing” designates an open enumeration and does not exclude other components apart from the expressly named components.

In the context of the present invention, the expression “consists of” or “consisting of” designates a closed enumeration and excludes any other components apart from the expressly named components.

In the context of the present invention, the expression “essentially consists of” or “essentially consisting of” designates a partially closed enumeration and designates preparations which apart from the named components only have such further components as do not materially alter the character of the preparation according to the invention.

When in the context of the present invention a preparation is described with the use of the expression “have” or “having”, this expressly includes preparations which consist of said components or essentially consist of said components.

In one embodiment of the invention, the resin composition or the hardener composition contains a maximum of 0.3, preferably 0.25 wt. % of wetting agent and is preferably essentially free from wetting agents.

In the context of the invention, the expression “essentially free from wetting agents” means that in the resin composition or the hardener composition no wetting agents whatever are present or the wetting agents are present in a quantity which is either undetectable or in which the wetting agents cannot exercise their function.

It has been found that by addition of wetting agents, the viscosity of resin compositions or hardener compositions which contain polyols or isocyanates and fillers in large quantities can admittedly be improved, however this also has the effect that the individual particles of the filler are better surrounded by the polymer, which leads to formation of thermally insulating layers between the individual particles and thus in some cases drastically worsens the thermal conductivity of a polymer produced therefrom. In view of this, for obtention of polymers with high polymers it is preferred according to the invention it is preferred if the resin compositions or hardener compositions contain only small quantities of wetting agent and are preferably free from wetting agents.

In a further embodiment, the aluminum hydroxide is present in the resin composition, in the hardener composition or the polymer in the form of at least four filler components,
wherein the first filler component has an average particle size of 75 to 150 μm, preferably 80 to 125 μm,
wherein the second filler component has an average particle size of 10 to 60 μm, preferably 30 to 50 μm,
wherein the third filler component has an average particle size of 1 to 5 μm, preferably 2 to 4 μm, and
wherein the fourth filler component has an average particle size of 3 μm or less, preferably 0.5 to 3 μm.

It has surprisingly been found that the use of aluminum hydroxide, which is made up of individual components in the aforesaid average particle sizes, it makes higher loading possible and as a result to achieve a high thermal conductivity in the polymer produced, without the viscosity of the resin composition or the hardener being so increased thereby that these for example are no longer usable for applications in molding processes.

In a further embodiment of the invention, at least one further filler component is present, which is selected from the group consisting of aluminum hydroxide, aluminum oxide, aluminum nitride, quartz, boron nitride, silicon carbide, magnesium oxide, calcium carbonate, barium sulfate, talc and mixtures thereof.

It has been found that by admixture of one or more filler components, the thermal conductivity of a polymer obtained from the compositions can once again be markedly increased, without thereby in turn worsening the viscosity of resin composition or the hardener composition too greatly.

In the case of addition of a filler which is not aluminum hydroxide, the possibility further exists, by addition of only smaller quantities of more expensive, but thermally highly effective fillers, such as for example boron nitride, of once again markedly increasing the thermal conductivity of a polymer obtained from the polymerizable resin composition or with use of the hardener composition, without the polymerizable resin composition or the hardener composition as a result no longer being economically profita-bly producible.

In the case of addition of a further filler component which is not aluminum hydroxide, this is not added into the aluminum hydroxide content. This means that the polymerizable resin composition must still always contain at least 75 wt. % of aluminum hydroxide, the hardener composition at least 70 wt. % of aluminum hydroxide and the polymer at least 50 vol.% of aluminum hydroxide.

In a further embodiment of the invention, the first, second, third and fourth filler component are present in the following ratios relative to 100% of the filler mixture:
first filler component: 40 to 60, preferably 45 to 55 wt. %,
second filler component: 5 to 25, preferably 10 to 20 wt. %,
third filler component: 10 to 30, preferably 15 to 25 wt. %,
fourth filler component: 5 to 25, preferably 10 to 20 wt. %,
wherein the optionally present further filler component(s) is/are added into the quantity of the filler component which comes closest to this with regard to the particle size.

In the context of the present invention, this means that, should for example a further filler component with an average particle size of 70 μm be added, that this is assigned to the first filler component, that is, the added further filler component together with the first filler component makes up 40 to 60, preferably 45 to 55 wt. % of the filler mixture. Should the further filler component for example have an average particle size of 8 μm, this would be added into the second filler component, whereby then in turn the further filler component and the second filler component together make up 5 to 25, preferably 10 to 20 wt. % of the filler mixture. This applies irrespective of whether or not this filler component is aluminum hydroxide, where the quantity of aluminum hydroxide must however be no lower than the minimum content.

In the context of the present invention, it is also entirely possible and en-visaged that more than one further filler component is added, where analogously to the above statements, these are in each case added into the filler component with the closest particle size. In every case it should once again be pointed out that all filler components which are not aluminum hydroxide are not added into the quantity of the aluminum hydroxide, in other words for example are present in the polymerizable resin composition in addition to the at least 75 wt. % of aluminum hydroxide.

In a further embodiment of the invention, the polymerizable resin composition relative to 100 wt. % of the resin composition comprises
5 to 25, preferably 15 to 25 wt. % of one or more polyols selected from the polyether polyols, the polyester polyols, the polybutadiene polyols and the hydrophobic aliphatic polyols,
0.0 to 2.5, preferably 0.5 to 1.5 wt. % of a short-chain ether alcohol, 0.0 to 0.25, preferably 0.0 to 0.15 wt. % of a wetting agent and
75 to 85 wt. % of aluminum hydroxide and optionally further additives, such as for example wetting and dispersant additives, dyes, pigments, drying agents, fillers, polyalcohols, butanediol, hexanediol, antifoaming agents, antisettling agents, and plasticizers such as for example phosphates and catalysts.

It has been found that a polymerizable resin composition with this composition is particularly suitable for producing thermally conducting polyurethane polymers which are for example of value in use in electrically powered vehicles.

In a further embodiment of the invention the resin composition has a viscosity of 1,600 to 30,000 mPa·s, preferably of 1,600 to 25,000 mPa·s at 50° C.

It has been found that polymerizable resin compositions with a viscosity in the aforesaid range are particularly suitable for use in molding processes, for example for the production of polymer molded articles. Viscosities stated in the context of the invention are measured at stage 4 or stage 8 on a Thermo Haake VT550® rotational viscosimeter with the test piece E100.

In a further embodiment of the invention, the polyurethane polymer according to the invention has a thermal conductivity of more than 1 W/m*K, measured according to ISO 22007-2:2008.

It has been found that polyurethane polymers with this minimum thermal conductivity have adequate thermal conductivity for example for use in electrically powered vehicles.

In a further embodiment of the invention, the polyurethane polymer has a Shore hardness of A30 to D90, preferably A30 to D50, measured according to ISO 868 or DIN 53505.

It has been found that polyurethane polymers with this hardness have adequate flexibility and damping action for example for use in electrically powered vehicles.

It goes without saying that the features mentioned above and those still to be explained below are useable not only in each particular combination given, but also in other combinations or singly, without departing from the scope of the present invention.

### DETAILED DESCRIPTION OF PREFERRED EMBODIMENTS

The invention is further described and explained below with reference to the following non-limiting examples.

### Examples

Using the ingredients described below in the quantities stated in Table 1, polymerizable resin compositions and hardener compositions were produced by mixing and homogenization. The compositions thus obtained were stored without problems until use.

TABLE 1

| Ingredient | | | | |
|---|---|---|---|---|
| [wt.-%] | Example 1 | Example 2 | Example 3 | Example 4 |
| WEVOPUR 60010 | 25 | 0 | 0 | 0 |
| WEVOPUR 60011 | 0 | 20 | 0 | 0 |
| WEVOPUR 60012 | 0 | 0 | 20 | 0 |
| WEVOPUR PD | 0 | 0 | 0 | 25 |
| 60013 | | | | |
| Filler 1 | 37.50 | 40 | 40 | 37.3 |
| Filler 2 | 22.50 | 24 | 24 | 22.9 |
| Filler 3 | 15 | 16 | 16 | 14.8 |

Fillers:

Filler 1
Type: particulate Al(OH)₃
Average particle size: 125 μm

Filler 2
Type: particulate Al(OH)₃
Average particle size: 6 μm (bimodal particle size distribution, average particle size of the first component about 40 μm, average particle size of the second component about 2 μm, ratio ca. 1:1)

Filler 3
Type: particulate Al(OH)₃
Average particle size: 2.7 μm
The products WEVOPUR 60010, WEVOPUR 60011, WEVOPUR 60012 and WEVOPUR PD 60013 are unfilled polyol-based resin compositions, which are commercially available from WEVO Chemie, Ostfildern-Kemnat, Germany.

The mixture of example 1 has a viscosity at 50° C. of 3,000 to 4,000 mPa·s.

For the production of a polyurethane polymer according to the invention, the polymer mixture of example 1 was mixed with 6 parts of an isocyanate with an NCO content of 32.5%, passed into a mold and then hardened at 80° C. for 24 hours. The polymer obtained had a Shore-A hardness of 68 and a thermal conductivity on the upper side of 1.19 Wm/*K and on the lower side of 1.25 W/m*K and thus displayed thermal conductivity very favorable for use in the field of electrically powered vehicles.

What is claimed is:

1. A polymerizable resin composition comprising at least one polymerizable resin component selected from the group consisting of polyols, polyamines and mixtures thereof, wherein said polymerizable resin contains at least 75 wt. % of aluminum hydroxide relative to 100 wt. % of the resin composition.

2. The polymerizable resin composition of claim 1, wherein said polyols are selected from the group comprising polyether polyols, polyester polyols, and polybutadiene polyols.

3. The polymerizable resin composition of claim 1 comprising additives selected from the group comprising wetting and dispersant additives, dyes, pigments, drying agents, fillers, polyalcohols, butanediol, hexanediol, antifoaming agents, antisettling agents, plasticizers such as phosphates, and catalysts.

4. The polymerizable resin composition of claim 1, wherein said polymerizable resin contains 75 to 85 wt. % of aluminum hydroxide relative to 100 wt. % of the resin composition.

5. The polymerizable resin composition of claim 3, wherein a content of said wetting agent is at most 0.3 wt. %.

6. The polymerizable resin composition of claim 5, wherein said content of said wetting agent is at most 0.25 wt. %.

7. The polymerizable resin composition of claim 1, wherein said aluminum hydroxide is present in the form of at least four filler components,
wherein the first filler component has an average particle size of 75 to 150 μm,
wherein the second filler component has an average particle size of 10 to 60 μm,
wherein the third filler component has an average particle size of 1 to 5 μm, and
wherein the fourth filler component has an average particle size of 3 μm or less.

8. The polymerizable resin composition of claim 7, wherein
said first filler component has an average particle size of 80 to 125 μm,
said second filler component has an average particle size of 30 to 50 μm,
said third filler component has an average particle size of 2 to 4 μm, and
said fourth filler component has an average particle size of 0.5 to 3 μm.

9. The polymerizable resin composition of claim 7, wherein a further filler component selected from the group consisting of aluminum hydroxide, aluminum oxide, aluminum nitride, quartz, boron nitride, silicon carbide, magnesium oxide, calcium carbonate, barium sulfate, talc and mixtures thereof, is present.

10. The polymerizable resin composition of claim 7, when said first, second, third and fourth filler component are present in the following proportions relative to 100% of the filler mixture:
first filler component: 40 to 60 wt. %,
second filler component: 5 to 25 wt. %,
third filler component: 10 to 30 wt. %,
fourth filler component: 5 to 25 wt. %,
wherein an optionally present further filler component(s) is/are assigned to the quantity of the filler component which comes closest to this with regard to the particle size.

11. The polymerizable resin composition of claim 10, wherein the proportion of said first filler component is 45 to 55 wt. %, of said second filler component 10 to 20 wt. %, of said third filler component 15 to 25 wt. % and of said fourth filler component 10 to 20 wt. %.

12. The polymerizable resin composition of claim 1, wherein relative to 100 wt. % of the resin composition it comprises:
5 to 25 wt. % of at least one polyol selected from the polyether polyols, polyester polyols, polybutadiene polyols, and hydrophobic aliphatic polyols,
0.05 to 2.5 wt. % of a short-chain ether alcohol,
0.0 to 0.25 wt. % of a wetting agent, and
75 to 85 wt. % of aluminum hydroxide,
and optionally further additives, such as for example wetting and dispersant additives, dyes, pigments, drying agents, fillers, polyalcohols, butanediol, hexanediol, antifoaming agents, antisettling agents, and plasticizers such as for example phosphates and catalysts.

13. The polymerizable resin composition of claim 12, wherein it comprises
15 to 25 wt. % of said polyols,
0.5 to 1.5 wt. % of said short-chained ether alcohol, and
0.0 to 0.15 wt. % of said wetting agent.

14. The polymerizable resin composition of claim 1, wherein said resin composition has a viscosity of 1,600 to 30,000 mPa·s, at 50° C.

15. The polymerizable resin composition of claim 15, wherein said resin composition has a viscosity of 1,600 to 25,000 mPa·s, at 50° C.

16. A hardener composition comprising at least one hardener component selected from the group consisting of aliphatic and aromatic isocyanates, selected from the group comprising methylene diphenyl diisocyanate, hexamethylene diisocyanate, toluene diisocyanate and prepolymers thereof, and aluminum hydroxide, wherein said hardener composition contains at least 70 wt. % of aluminum hydroxide relative to 100 wt. % of the hardener composition.

17. The hardener composition of claim 16, wherein said content of said aluminum hydroxide is from 70 to 85 wt. %.

18. The hardener composition of claim 16, comprising further additives selected from the group comprising wetting and dispersant additives, dyes, pigments, drying agents, fillers, antifoaming agents, antisettling agents, plasticizers such as phosphates, and catalysts.

19. The hardener composition of claim 18, wherein a content of said wetting agent is at most 0.3 wt. %.

20. The hardener composition of claim 19, wherein said content of said wetting agent is at most 0.25 wt. %.

21. The hardener composition of claim 16, wherein said aluminum hydroxide is present in the form of at least four filler components,
wherein the first filler component has an average particle size of 75 to 150 μm,
wherein the second filler component has an average particle size of 10 to 60 μm,
wherein the third filler component has an average particle size of 1 to 5 μm, and
wherein the fourth filler component has an average particle size of 3 μm or less.

22. The hardener composition of claim 21, wherein
said first filler component has an average particle size of 80 to 125 μm,
said second filler component has an average particle size of 30 to 50 μm,
said third filler component has an average particle size of 2 to 4 μm, and
said fourth filler component has an average particle size of 0.5 to 3 μm.

23. The hardener composition of claim 16, wherein a further filler component, selected from the group consisting of aluminum hydroxide, aluminum oxide, aluminum nitride, quartz, boron nitride, silicon carbide, magnesium oxide, calcium carbonate, barium sulfate, talc and mixtures thereof, is present.

24. The hardener composition of claim 21, wherein said first, second, third and fourth filler component are present in the following proportions relative to 100% of the filler mixture:
first filler component: 40 to 60 wt. %,
second filler component: 5 to 25 wt. %,
third filler component: 10 to 30 wt. %,
fourth filler component: 5 to 25 wt. %,
wherein an optionally further filler component(s) is/are assigned to the quantity of the filler component which comes closest to this with regard to the particle size.

25. The hardener composition of claim 24, wherein said proportions are as follows:
first filler component 45 to 55 wt. %,
second filler component 10 to 20 wt. %,
third filler component 15 to 25 wt. %,
fourth filler component 10 to 20 wt. %.

26. (canceled)

27. A polymer selected from polyurethanes, polyureas and mixtures or copolymers thereof, wherein it contains volume percents of aluminum hydroxide relative to 100 vol.% of the polymer selected from the following contents, more than 50 vol.%, more than 55 vol.% and more than 60 vol.%.

28. The polymer of claim 27, wherein said aluminum hydroxide is present in the form of at least four filler components,
wherein the first filler component has an average particle size of 75 to 150 μm,
wherein the second filler component has an average particle size of 10 to 60 μm,
wherein the third filler component has an average particle size of 1 to 5 μm, and
wherein the fourth filler component has an average particle size of 3 μm or less.

29. The polymer of claim 28, wherein
said first filler component has an average particle size of 80 to 125 μm,
said second filler component has an average particle size of 30 to 50 μm,
said third filler component has an average particle size of 2 to 4 μm, and
said fourth filler component has an average particle size of 0.5 to 3 μm.

30. The polymer of claim 28, wherein said further filler component, selected from the group consisting of aluminum hydroxide, aluminum oxide, quartz, boron nitride, silicon carbide, magnesium oxide, barium sulfate, talc and mixtures thereof, is present.

31. The polymer of claim 28, wherein said first, second, third and fourth filler component are present in the following proportions relative to 100% of the filler mixture:
first filler component: 40 to 60 wt. %,
second filler component: 5 to 25 wt. %,
third filler component: 10 to 30 wt. %,
fourth filler component: 5 to 25 wt. %,
wherein an optionally present further filler component(s) is/are assigned to the quantity of the filler component which comes closest to this with regard to the particle size.

32. The polymer of claim 31, wherein said proportions are as follows:
first filler component 45 to 55 wt. %,
second filler component 10 to 20 wt. %,
third filler component 15 to 25 wt. %,
fourth filler component 10 to 20 wt. %.

33. The polymer of claim 28, wherein it has a thermal conductivity of more than 1 W/m*K, measured according to ISO 22007-2:2008.

34. The polymer of claim 28, wherein it has a Shore hardness of A30 to D90, preferably A30 to D50, measured according to ISO 868 or DIN 53505.

35. An inorganic filler mixture which contains aluminum hydroxide, wherein said aluminum hydroxide is present in the form of at least four filler components,
wherein the first filler component has an average particle size of 75 to 150 μm,
wherein the second filler component has an average particle size of 10 to 60 μm,
wherein the third filler component has an average particle size of 1 to 5 μm, and
wherein the fourth filler component has an average particle size of 3 μm or less.

36. The inorganic filler mixture of claim 35,
wherein said first filler component has an average particle size of 80 to 125 μm,
wherein said second filler component has an average particle size of 30 to 50 μm,
wherein said third filler component has an average particle size of 2 to 4 μm, and
wherein said fourth filler component has an average particle size of 0.5 to 3 μm,

37. The inorganic filler mixture of claim 35, further containing a further filler component, selected from the group consisting of aluminum hydroxide, aluminum oxide, aluminum nitride, quartz, boron nitride, silicon carbide, magnesium oxide, calcium carbonate, barium sulfate, talc and mixtures thereof.

38. The inorganic filler mixture of claim 35, wherein said first, second, third and fourth filler component are present in the following proportions relative to 100% of the filler mixture:
first filler component: 40 to 60 wt. %,
second filler component: 5 to 25 wt. %,
third filler component: 10 to 30 wt. %,
fourth filler component: 5 to 25 wt. %,
wherein an optionally present further filler component(s) is/are assigned to the quantity of the filler component which comes closest to this with regard to the particle size.

39. The inorganic filler mixture of claim 38, wherein said proportions are as follows:
first filler component: 45 to 44 wt. %,
second filler component: 10 to 20 wt. %,
third filler component: 15 to 25 wt. %,
fourth filler component: 10 to 20 wt. %.

40. Use of an inorganic filler mixture of claim 35, for improving the thermal conductivity of polymers.

41. A polymerizable resin composition comprising at least one polymerizable resin component selected from the group consisting of polyols, polyamines and mixtures thereof, said polyols being selected from the group comprising polyether polyols, polyester polyols, and polybutadiene polyols, and optionally further additives, selected from the group comprising wetting and dispersant additives, dyes, pigments, drying agents, fillers, polyalcohols, butanediol, hexanediol, antifoaming agents, antisettling agents, plasticizers such as phosphates, and catalysts, wherein the resin composition contains an inorganic filler mixture as claimed in claim 35.

42. A hardener composition comprising at least one hardener component selected from the group of aliphatic and aromatic isocyanates, selected from the group comprising methylene diphenyl diisocyanate, hexamethylene diisocyanate, toluene diisocyanate and prepolymers thereof, and further additives, selected from the group comprising wetting and dispersant additives, dyes, pigments, drying agents, fillers, antifoaming agents, antisettling agents, plasticizers such as for example phosphates, and catalysts, wherein said hardener composition contains an inorganic filler mixture as claimed in claim 35.

43. A polymer selected from the polyurethanes, polyureas and mixtures or copolymers thereof, wherein it contains an inorganic filler mixture as claimed in claim 35.
